(19) United States
(12) Patent Application Publication
(10) Pub. No.: US 2006/0078849 A1
(43) Pub. Date: Apr. 13, 2006

(54) Dental splint

(76) Inventor: Cynthia D. Parks, Cleveland, OH (US)

Correspondence Address: Cynthia D. Parks, Route 1, Box 251, Eglon, WV, 26716, US

(21) Appl. No.: 10/963,240

(22) Filed: Oct. 12, 2004

(51) Int. Cl. A61C 5/00; A61C 3/00

(52) U.S. Cl. 433/215; 433/18

(57) ABSTRACT

A dental splint comprising a plurality of splint posts and a strip interconnecting the plurality of splint posts, wherein at least one of the splint posts has a resin thereon. One or more of the plurality of splint posts may include a removable peel strip for covering the resin. One or more of the plurality of splint post may be fixed to the strip and one or more of the plurality of splint posts may be movable relative to the strip. One or more of the plurality of splint posts may include a groove operable to accept a wire. Methods of applying the dental splint and for securing a broken jaw using the dental splint are also provided.

### BACKGROUND

The present invention relates generally to a temporary dental splint for stabilizing teeth and/or jaw parts having undesirable mobility.

A dental splint may be used to stabilize a loose or dislocated tooth. Typically, the loose or dislocated tooth is repositioned and temporarily splinted to one or more adjacent, non-mobile teeth. For example, the loose tooth may be splinted to a left adjacent, non-mobile tooth and to a right adjacent, non-mobile tooth (such a splint may be referred to as a “bridge splint”). As a further example, the loose tooth or dislocated tooth may be splinted to one or more left adjacent, non-mobile teeth, or to one or more right adjacent, non-mobile teeth (such a splint may be referred to as a “cantilever splint”). The splint may remain in place for several days or weeks until the loose tooth becomes non-mobile and there is no sign of root resorption.

FIG. 22 illustrates a prior art dental splint 72 applied to the lower right lateral incisor 52, lower right central incisor 50 and the lower left central incisor 51, for example, as a bridge splint (i.e., wherein the lower right central incisor 50 is mobile). Prior to applying the dental splint 72, the lower right lateral incisor 52, lower right central incisor 50 and the lower left central incisor 51 are cleaned, etched, rinsed, and thoroughly dried. A bonding agent (not shown) is then applied to the lower right lateral incisor 52 and cured using an ultraviolet or visible light. The bonding agent is then applied to the lower right central incisor 50 and cured. Finally, the bonding agent is applied to the lower left central incisor 51 and cured.

A large amount of resin or composite 75 is then applied to the lower right lateral incisor 52. The splint 72 is then pressed into the resin 75 and positioned as desired. More resin 75 may be applied as necessary. The resin 75 is then cured using the ultraviolet or visible light. The resin 75 is then applied to the lower right central incisor 50, the splint 72 pressed into the resin 75 and positioned as desired, and the resin 75 is cured. Finally, the resin 75 is applied to the lower left central incisor 51, the splint 72 pressed into the resin 75 and positioned as desired, and the resin 75 is cured.

The prior art dental splint 72 may also be used to secure a broken or injured jaw. For example, a first dental splint 72 may be applied to one or more upper teeth (i.e., teeth located in the upper jaw or maxilla) and a second dental splint 72 may be applied to one or more lower teeth (i.e., teeth located in the lower jaw or mandible). The first and second splints 72 may then be interconnected using one or more wires or bands.

The prior art dental splint 72 illustrated in FIG. 22 is difficult to install onto and remove from a patient's teeth. For example, the teeth to which the splint 72 is secured must remain dry for the bonding agent to properly adhere to the tooth's surface. This is difficult to accomplish due to the number of steps that must be completed when applying the bonding agent to each tooth. Additionally, the bonding agent must be thoroughly cured and remain dry for the resin 75 to properly adhere to the bonding agent. Again, this is difficult to accomplish due the number of steps required to apply the resin 75 and the splint 72. Furthermore, the large amount of resin 75 that is used to secure the splint 72 to the teeth is difficult to strip off from the teeth when the splint 72 is removed.

Accordingly, a need exists for a dental splint that is easy to apply and remove and which overcomes the limitations inherent in prior art.

### SUMMARY

One aspect of the invention relates to a dental splint comprising a plurality of splint posts, at least one of the splint posts having a resin thereon, and a strip interconnecting the plurality of splint posts.

Another aspect of the invention relates to a method of applying a dental splint comprising securing a first splint post to a mobile tooth, securing a second splint post to a non-mobile tooth, wherein at least one of the first and second splint posts includes a resin thereon, and interconnecting the one or more splint posts with a strip.

Another aspect of the invention relates to a method of applying a dental splint comprising securing a first splint post to a mobile tooth and securing a second splint post to a non-mobile tooth, wherein the first and second splint posts are interconnected by a strip and wherein at least one of the first and second splint posts includes a resin thereon.

### BRIEF DESCRIPTION OF THE DRAWINGS

To enable the present invention to be easily understood and readily practiced, the present invention will now be described for purposes of illustration and not limitation, in connection with the following figures wherein:

FIG. 1 is a perspective view of the front of a dental splint according to one embodiment.

FIG. 2 is a simplified front-view of the splint shown in FIG. 1 according to one embodiment.

FIG. 3 is perspective view of the back of the splint shown in FIG. 1 according to one embodiment.

FIG. 4 is a simplified back-view of the splint shown in FIG. 1 according to one embodiment.

FIG. 5 is a simplified side-view of the splint shown in FIGS. 1-4 according to one embodiment.

FIG. 5A is an exploded view of a splint post for the splint shown in FIG. 5 according to one embodiment.

FIGS. 5B and 5C are detailed views of the splint post of FIG. 5A according to one embodiment.

FIG. 6 illustrates the use of the splint shown in FIGS. 1-5 according to one embodiment.

FIG. 7 is a simplified side-view of the dental splint shown in FIG. 1 according to another embodiment.

FIG. 7A is an exploded view of the splint post for the splint shown in FIG. 7 according to one embodiment.

FIG. 8 illustrates the use of the splint shown in FIG. 7 according to one embodiment.

FIG. 9 is a simplified view of a bulk supply of the dental splint shown in FIGS. 1-5 and FIG. 7 according to one embodiment.

FIG. 10 is a simplified front-view of a dental splint according to another embodiment.

FIG. 11A is a cross-sectional view of the splint shown in FIG. 10 along line 11a-11a according to one embodiment.

FIG. 11B is a cross-sectional view of the splint shown in FIG. 10 along line 11b-11b according to one embodiment.

FIG. 12 is a perspective view a splint post for the dental splint of FIG. 10 according to one embodiment.

FIG. 13 is a simplified front-view of a dental splint having a fixed splint post on one end according to one embodiment.

FIG. 14A is a simplified side-view of a dental splint according to another embodiment.

FIG. 14B is a simplified top-view of the dental splint of FIG. 14 according to one embodiment.

FIG. 15 is an exploded, perspective view of a splint post for the dental splint of FIGS. 14A and 14B according to one embodiment.

FIG. 16 illustrates the installation of the splint shown in FIGS. 14A and 14B according to one embodiment.

FIG. 17 illustrates the installation of the splint shown in FIGS. 14A and 14B according to another embodiment.

FIG. 18 is a perspective view of the front of a dental splint according to another embodiment.

FIG. 19A is a simplified side view of a dental splint according to another embodiment.

FIG. 19B is a simplified top view of the dental splint shown in FIG. 19A according to one embodiment.

FIG. 20 is an exploded, perspective view of a splint post for the dental splint of FIGS. 19A and 19B according to one embodiment.

FIG. 21 illustrates the installation of the splint shown in FIGS. 19A and 19B according to one embodiment.

FIG. 22 illustrates the use of a prior art dental splint.

### DETAILED DESCRIPTION

The detailed description sets forth specific embodiments which are described in sufficient detail to enable those skilled in the art to practice the present invention. It should be apparent to those skilled in the art that other embodiments may be utilized while remaining within the scope of the present invention. The following detailed description is, therefore, not to be taken in a limiting sense, and the scope of the invention is defined only by the appended claims.

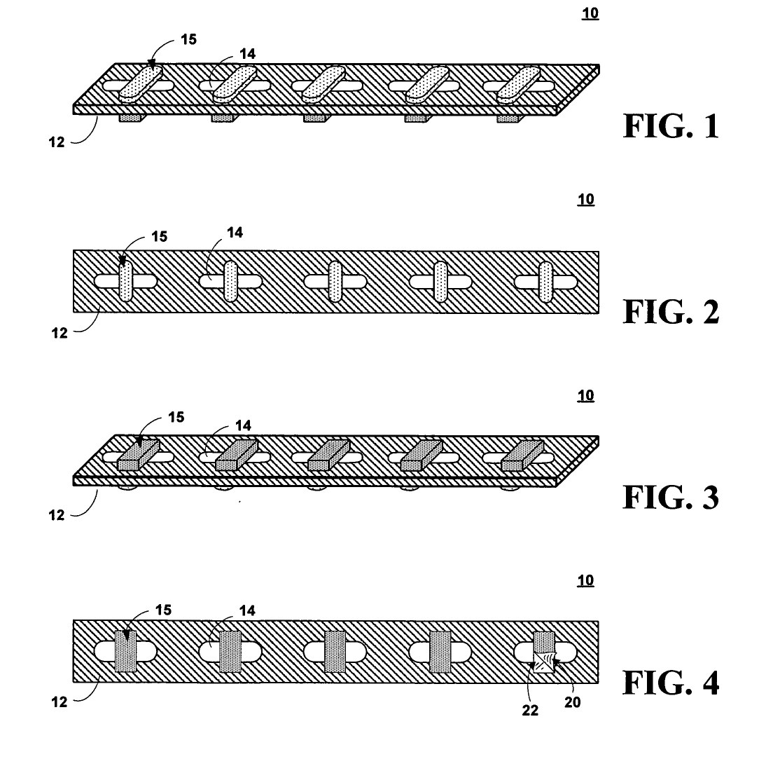

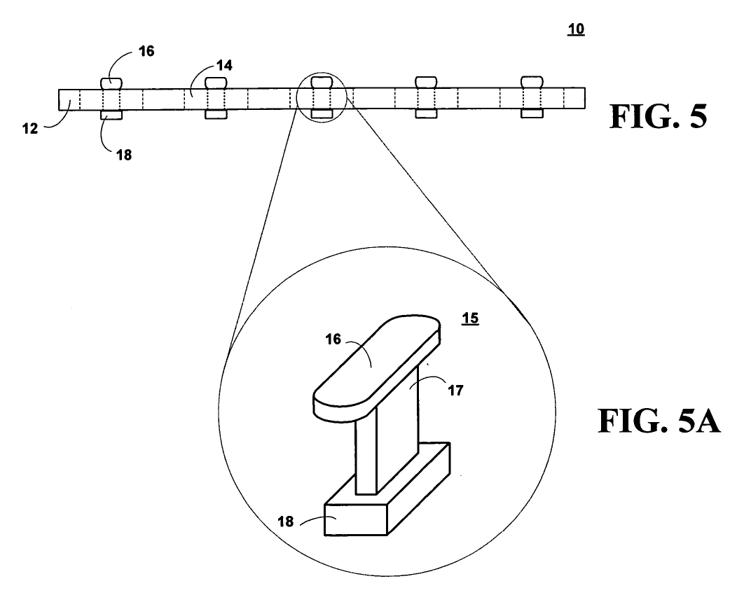

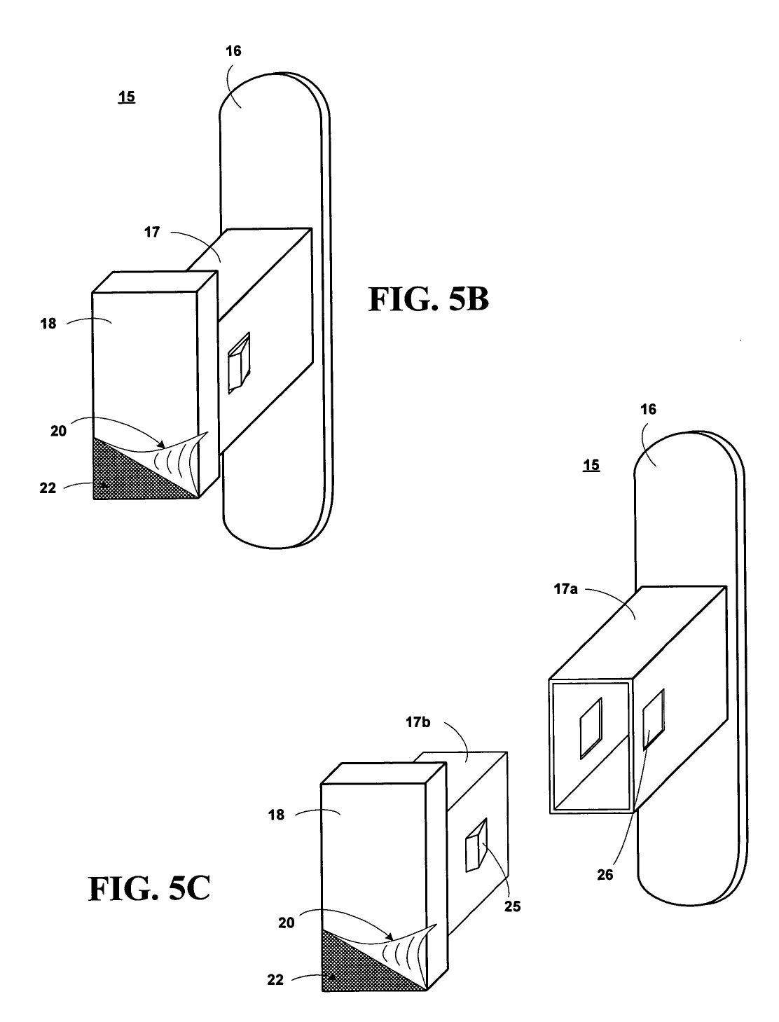

FIGS. 1 and 2 are a perspective view and a simplified view, respectively, of the front of a dental splint 10, whereas FIGS. 3 and 4 are a perspective view and a simplified view, respectively, of the rear of the dental splint 10 according to one embodiment. FIG. 5 is a simplified side view of the dental splint 10 illustrated in FIGS. 1-4 according to one embodiment.

Referring to FIG. 1, dental splint 10 is comprised of a strip 12 having one or more slots 14 therein. In the current embodiment, the slots 14 are ovoidal in shape and are disposed along the longitudinal axis of the strip 12. Each slot 14 may have a splint post 15 associated therewith. The position of each splint post 15 may be adjusted within its associated slot 14. In the current embodiment, the strip 10 and/or splint posts 15 are made from a resilient plastic material (e.g., polypropylene), however, other materials (e.g., stainless steel) may be used while remaining within the scope of the present invention.

FIG. 5A is an exploded view of the splint post 15 for the dental splint 10 according to one embodiment. FIGS. 5B and 5C illustrate more detailed views of the splint post 15 of FIG. 5A according to one embodiment. The splint post 15 may include a top 16, a connecting member 17, a base 18, a peel strip 20, and a resin 22 (which may also be referred to herein as composite 22).

In the current embodiment, top 16 is ovoidal in shape and the base 18 is rectangular in shape, although other shapes may be used while remaining within the scope of the present invention. The resin 22 is situated on the bottom surface of the base 18 and is covered by the removable peel strip 20. The resin 22 may be, for example, a hybrid resin, a microfill resin, macrofill resin, and/or a minifill resin, among others. The resin 22 is used to secure the splint post 15 (and thus the splint 10) to the patient's teeth. It should be apparent to one skilled in the art that other substances which are capable of properly adhering the splint 10 to the patient's teeth may be used while remaining within the scope of the present invention.

As best illustrated in FIG. 5C, the connecting member 17 may be comprised of a female portion 17a and a male portion 17b. The female portion 17a may have one or more notches 26, whereas the male portion 17b may have one or more latches 25. In the current embodiment, the latches 25 lockably engage the notches 26 when the male portion 17b is inserted into the female portion 17a (as best illustrated in FIG. 5B).

In the current embodiment, the female portion 17a of the connecting member 17 is inserted through one of the slots 14 (relative to the front surface of strip 12) with top 16 aligned transverse to the longitudinal axis of strip 12. The male portion 17b of the connecting member 17 is then inserted through the slot (relative to the rear surface of the strip 12) and into the female portion 17 with base 18 aligned transverse to the longitudinal axis of strip 12. The female portion 17a and the male portion 17b are pressed together until latches 25 engage notches 26.

In the current embodiment, the length of the connecting member 17 may be selected such that, when latches 25 engage notches 26, the bottom side of top 16 remains in contact with the front surface of strip 12 and the top of base 18 remains in contact with the rear surface of strip 12. Accordingly, the splint post 15 may be moved within the slot 14 with the application of a certain amount of force, but is not so free as to fail to provide support to the mobile tooth. More specifically in the current embodiment, the slot 14 and splint post 15 combination provides sufficient support to stabilize the mobile tooth while allowing a certain amount of physiological movement so as to prevent ankylosis (i.e., to prevent the mobile tooth from fusing to the maxilla or mandible).

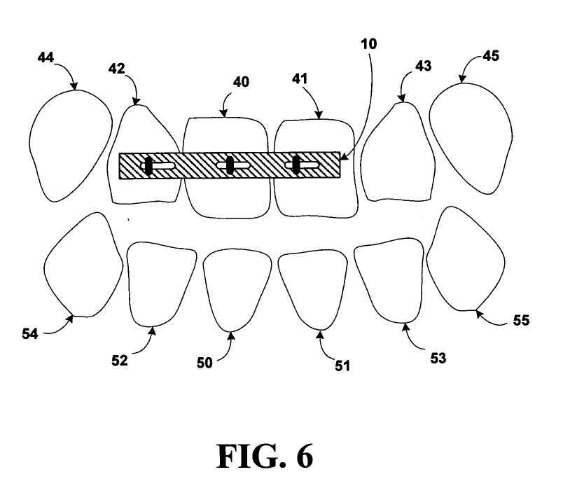

FIG. 6 illustrates the use of the splint 10 shown in FIGS. 1-5 according to one embodiment. The splint 10 in the current embodiment is being used as a bridge splint to interconnect a mobile upper right central incisor 40 to a non-mobile, adjacent upper right lateral incisor 42 and a non-mobile, upper left central incisor 41. The upper right central incisor 40 is aligned into its desired position. In one embodiment, the splint 10 may be dry fitted by placing the splint 10 across teeth 42, 40, 41 and adjusting each splint post 15 within its associated slot 14 until the base 18 of each splint post 15 is aligned to provide the best contact with the surface of its associated tooth.

After dry fitting, the upper right lateral incisor 42, the upper right central incisor 40, and the upper left central incisor 41 are cleaned, etched, rinsed, and dried. Cleaning may include removing blood, dirt, foreign matter, etc. that may be present, for example, as a result of trauma to the patient's mouth. Etching may be completed, for example, using a solution of phosphoric acid. Rinsing and drying may be completed using water and compressed air, respectively. After the teeth are dried, the peel strip 20 is removed from the bottom surface of base 18 of each splint post 15 to reveal the resin 22. Each base 18, with the exposed resin 22, is then positioned (e.g., aligned and pressed against) relative to the etched surface of a tooth (i.e., one splint post 15 is secured to each of the upper right lateral incisor 42, the upper right central incisor 40, and upper left central incisor 41). Final positioning adjustments for each base 18 relative to the surface of its associated tooth may then be made. The resin 22 is then cured, for example, using an ultraviolet or visible light, to secure the splint 10 to the patient's teeth.

In an alternative embodiment, the peel strip 20 may be removed (and the resin 22 exposed) from the bottom one base 18 at a time. The base 18 with the exposed resin 22 is then positioned relative to its associated tooth and secured (the associated tooth may be cleaned, etched, rinsed, and dried as discussed above). For example, the peel strip 20 may be removed from the base 18 which is to be secured to the upper right lateral incisor 42. The base 18 with the exposed resin 22 is then aligned and pressed against the etched surface of the upper right lateral incisor 42 and the resin 22 is cured, for example, using an ultraviolet or visible light. Next, the peel strip 20 may be removed from the base 18 which will be secured to the upper right central incisor 40. The base 18 with the exposed resin 22 is then aligned and pressed against the etched surface of the upper right central incisor 40 and the resin 22 cured. Finally, the peel strip 20 may be removed from the base 18 which will be secured to the upper left central incisor 41. The base 18 with the exposed resin 22 is then aligned pressed against the etched surface of the upper left central incisor 41 and the resin 22 cured.

It should be apparent to one skilled in the art that other methods of attaching the splint 10 to the teeth may be employed while remaining within the scope of the present invention. For example, a bonding agent may first be applied and cured onto the upper right central incisor 40, the upper right lateral incisor 42, and upper left central incisor 41 prior to attaching the splint 10 to the teeth. The bonding agent may improve the ability of the resin 22 to adhere to the surface of the teeth.

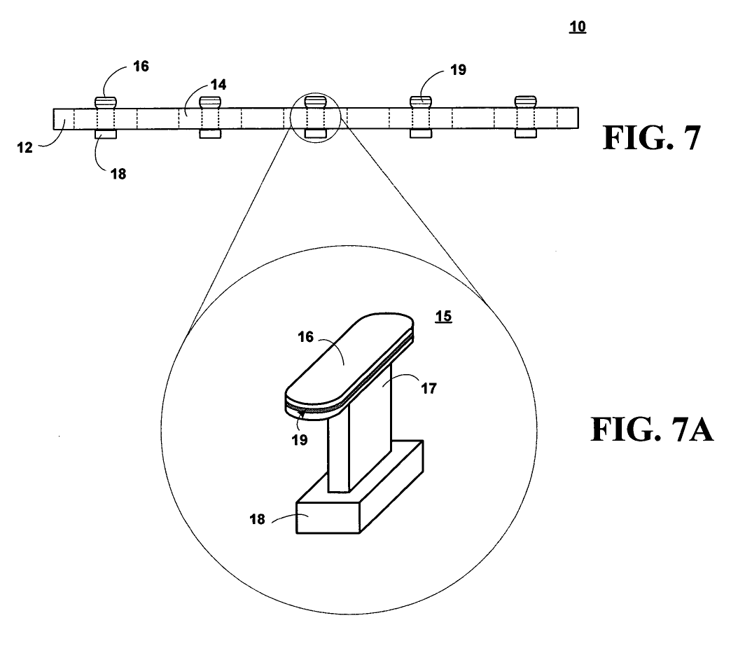

FIG. 7 is a simplified side-view of the dental splint 10 shown in FIG. 1 according to another embodiment. This dental splint 10 utilizes a splint post 15 which includes a groove 19 in the top 16 (as best seen in FIG. 7A, which is an exploded view of a splint post 15 according to the current embodiment). The groove 19 is adapted to accept a wire or band, for example, for securing a broken jaw.

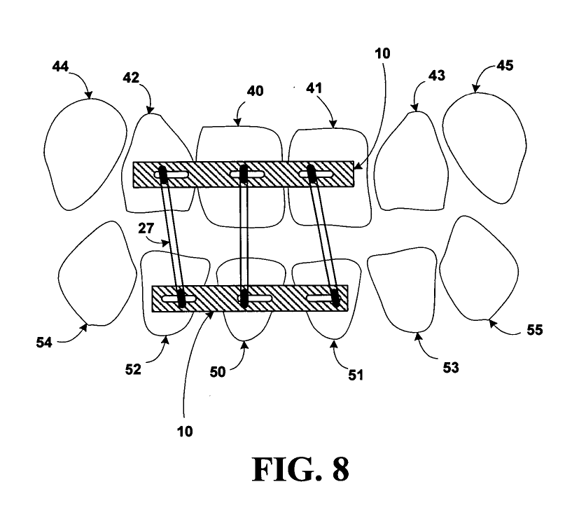

FIG. 8 illustrates the use of the splint 10 illustrated in FIG. 7 according to one embodiment. More specifically, two splints 10 are illustrated, one attached to the buccal surfaces of teeth in the maxilla (upper jaw) and another attached to the buccal surfaces of teeth in the mandible (lower jaw). The splints 10 are shown interconnected in an intermaxillary manner, thus securing the maxilla and mandible together. Wires 27 are looped around the tops 16 of the splint 10 secured to the teeth in the maxilla and around corresponding tops 16 of the splint 10 secured to teeth in the mandible. In the current embodiment, the wires 27 fit within the grooves 19 in each top 16. The grooves 19 help to secure the wires 27 and prevent the wires 27 from cutting or pinching the patient's gums, cheeks, etc.

In one embodiment, the first splint is applied to one or more teeth located in the maxilla and the second splint is applied to one or more teeth located in the mandible. The first splint and the second splint are then interconnected. At least one of the first splint and the second splint are applied by securing a splint post to each of the one or more teeth as discussed above in conjunction with FIG. 6.

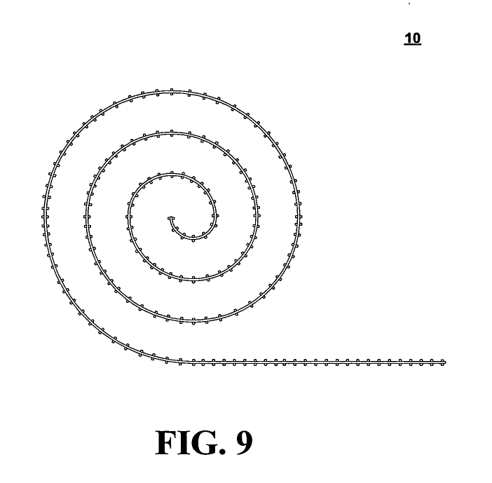

FIG. 9 is a simplified view of a bulk supply of the dental splint 10 shown in FIGS. 1 and 7 according to one embodiment. As illustrated, the dental splint 10 may come in a roll such that a doctor or dentist may easily choose the length of splint 10 needed for a particular patient by simply cutting off the splint 10 at the desired length. It should be apparent to one skilled in the art that other bulk supplies for the splint 10 are contemplated by the present invention. For example, the splints 10 may be shipped in standard lengths that may be used as is, or trimmed to a desired length.

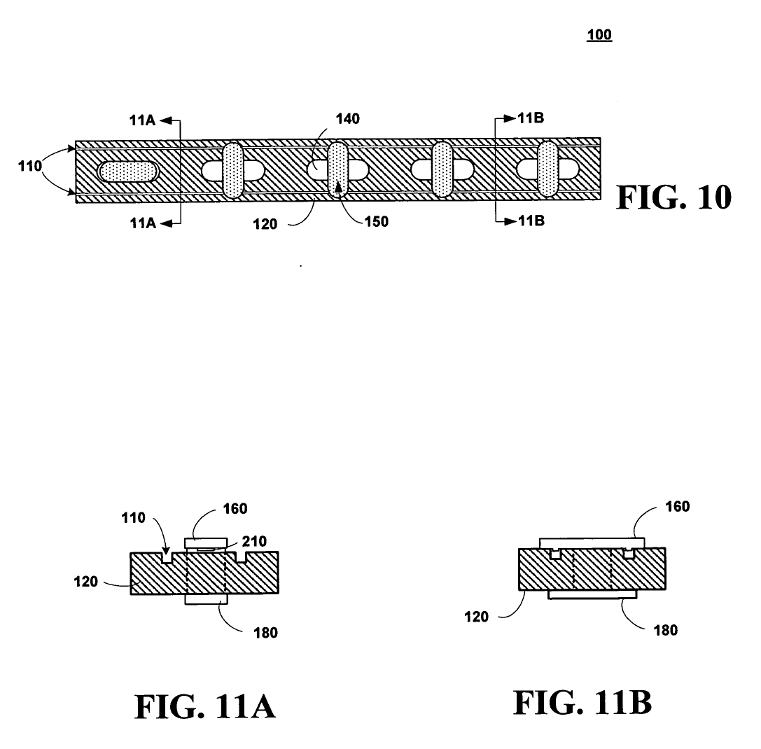

FIG. 10 is a simplified front-view of a splint 100 according to another embodiment of the present invention. The splint 100 includes a strip 120 having one or more slots 140 therein. In the current embodiment, the slots 140 are ovoidal in shape and are disposed along the longitudinal axis of the strip 120. Each slot 140 may have a splint post 150 associated therewith. The position of each splint post 150 may be adjusted within its associated slot 140. The strip 120 also includes one or more channels 110 disposed along the longitudinal axis of the strip 120. The channels 110 prevent rotation of the splint posts 150 as will be described herein below. In the current embodiment, the strip 100 and/or splint posts 150 are made from a resilient plastic material (e.g., polypropylene), however, other materials (e.g., stainless steel) may be used while remaining within the scope of the present invention.

FIG. 12 is a perspective view of splint post 150 for the dental splint 100 of FIG. 10 according to one embodiment. The splint post 150 may include a top 160, a connecting member 170, and a base 180, a peel strip 20, and a resin 22. In the current embodiment, top 160 is ovoidal in shape includes two keys 210 at either end of the top 160. The connecting member 170 is cylindrical in shape, whereas the base 180 is rectangular in shape. It should be apparent to one skilled in the art that other shapes may be used while remaining within the scope of the present invention.

In the current embodiment, the resin 22 is situated on the bottom surface of the base 180 and is covered by the removable peel strip 20. The resin 22 may be, for example, a hybrid resin, a microfill resin, macrofill resin, and/or a minifill resin, among others. The resin 22 is used to secure the splint post 150 (and thus the splint 100) to the patient's teeth. It should be apparent to one skilled in the art that other substances which are capable of properly adhering the splint 100 to the patient's teeth may be used while remaining within the scope of the present invention. In the current embodiment, the splint post 150 is of unitary construction, although other types of construction may also be within the scope of the present invention.

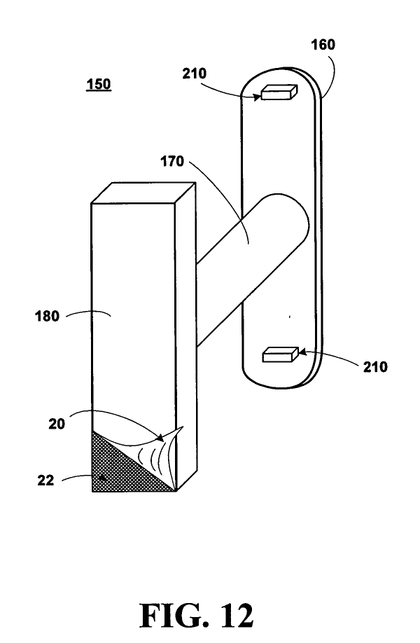

Referring now to FIG. 11A (which is a cross-sectional view of a portion of the splint 100 shown in FIG. 10), the splint post 150 is aligned with and inserted into a slot 140 of the splint 100 relative to the rear of strip 120 until the base 180 makes contact with the rear surface of strip 120. The splint post 150 is then rotated 90 degrees. As best illustrated in FIG. 11B (which is a cross-sectional view of another portion of the splint 100 shown in FIG. 10), the keys 210 align with and “snap into” channels 110 such that the top 160 and base 180 are positioned transverse to the longitudinal axis of strip 120. Once the keys 210 engage the channels 110, further rotation of the splint post 150 is impeded. The splint post 150, however, may move laterally within the slot 140 relative to the longitudinal axis of strip 120.

In the current embodiment, the splint post 150 may be moved within the slot 140 with the application of a certain amount of force, but is not so free as to fail to provide support to the mobile tooth. More specifically in the current embodiment, the slot 140 and splint post 150 combination provides sufficient support to stabilize the mobile tooth while allowing certain amount of physiological movement so as to prevent ankylosis (i.e., to prevent the mobile tooth from fusing to the jaw bone).

It should be apparent to one skilled in the art that other embodiments, which are within the scope of the present invention, are contemplated for the splint 100. For example, splint post 150 may include a groove (not shown) in top 160. The groove may be used to interconnect two or more splints 100 to secure a broken jaw, for example, as discussed above in conjunction with FIG. 8.

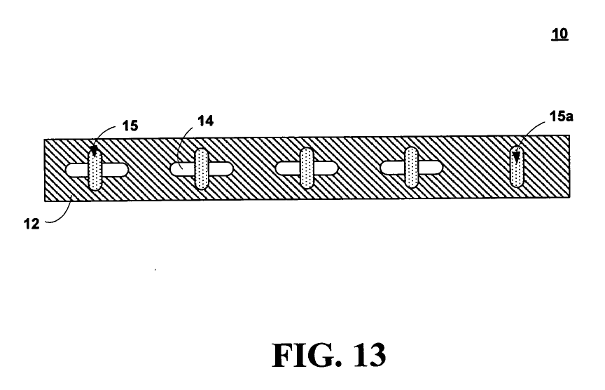

FIG. 13 is a simplified front-view of a dental splint 10 according to an alternative embodiment. Dental splint 10 includes a fixed splint post 15a. When the dental splint 10 is secured to a patient's teeth, the fixed splint post 15a may prevent, for example, excess movement of the strip 12 relative to the splint posts 15 while allowing a certain amount of physiological movement so as to prevent ankylosis. It should be apparent to one skilled in the art that the number of fixed splint posts 15a may be varied while remaining within the scope of the present invention. Furthermore, it should be apparent to one skilled in the art that a fixed splint post 15a may also be used with the splints 10, 100 illustrated in FIGS. 7 and 10, respectively, among others.

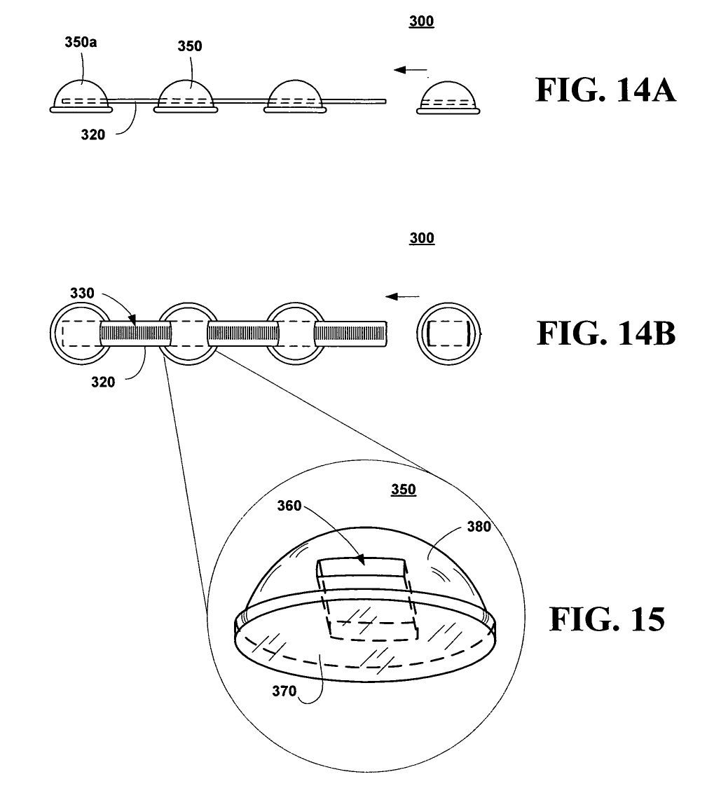

FIGS. 14A and 14B are a simplified side-view and a simplified top-view of a dental splint 300 according to another embodiment. Dental splint 300 includes a strip 320. Splint 300 also includes a plurality of splint posts 350, one or more which may be fixed (i.e., splint post 350a) to the strip 320. In the current embodiment, the strip 320 and/or splint posts 350 are made from a resilient plastic material (e.g., polypropylene), however, other materials (e.g., stainless steel) may be used while remaining within the scope of the present invention.

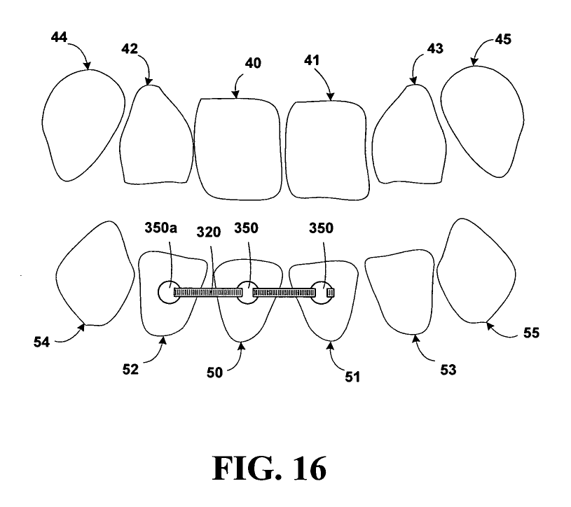

FIG. 15 is an exploded, perspective view of a splint post 350 for the dental splint 300 shown in FIGS. 14A and 14B according to one embodiment. The splint post 350 includes a flat base 370 and a domed top 380. Base 370 includes a peel strip (not shown) that that can be removed to expose a resin (not shown), which in the current embodiment is situated on the bottom surface of the base 370. The resin is used secure the splint post 350 to a patient's tooth.

Domed top 380 includes a passage 360 which allows the strip 320 to be inserted through the domed top 380. In the current embodiment, strip 320 has a plurality of ridges 330 located on the top surface thereof and the passage 360 includes one or more protrusions (not shown) that engage one or more of the ridges 330 on the strip 320. In combination, the protrusions and ridges 330 impede splint posts 350 from sliding relative to strip 320 once the splint posts 350 are adjusted to their desired position while allowing certain amount of physiological movement so as to prevent ankylosis. Additionally, the fixed splint post 350a may prevent, for example, excess movement of the strip 320 relative to the splint posts 350 when the dental splint 300 is secured to a patient's teeth, again while allowing certain amount of physiological movement so as to prevent ankylosis.

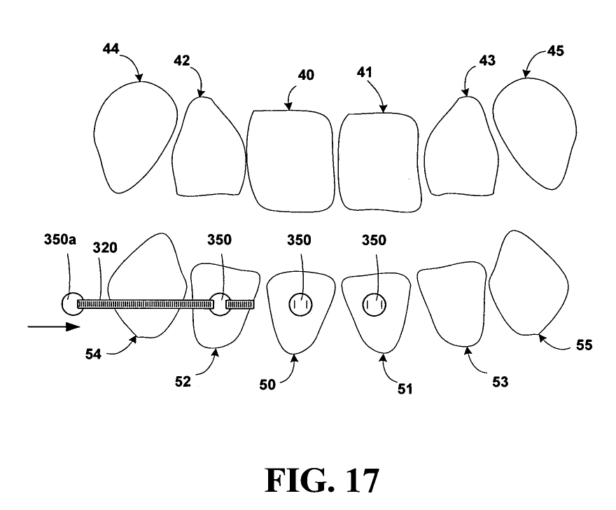

FIGS. 16 and 17 illustrate two different methods for applying the splint 300 to a patient's teeth. In the embodiment illustrated in FIG. 16, the splint 300 may be dry fitted by placing the splint 300 across the teeth (e.g., the lower right lateral incisor 52, the lower right central incisor 50, and the lower central incisor 51) and adjusting each splint post 350 relative to strip 320 so that the base 370 of each splint post 350 provides the best contact with the surface of the associated tooth. Each of the lower right lateral incisor 52, the lower right central incisor 50, and the lower left central incisor 51 are then cleaned, etched, rinsed, and dried. After drying, the peel strips are removed from the base 370 of each splint post 350, 350a to reveal a resin (not shown in FIG. 16). The bases 370, with the resin exposed, are then positioned (e.g., aligned and pressed against) relative to the etched surface of the teeth (i.e., the lower right lateral incisor 52, the lower right central incisor 50, and the lower central incisor 51). Final positioning of the bases 370 relative to the teeth may be made and the resin cured, for example using an ultraviolet or visible light, to secure the splint 300 to the teeth.

In the embodiment illustrated in FIG. 17, the lower right lateral incisor 52 is cleaned, etched, rinsed, and dried. The peel strip is removed from the base 370 of a splint post 350 to reveal a resin (not shown in FIG. 17). The base 370, with the resin exposed, is then aligned and pressed against the etched surface of the lower right lateral incisor 52. Final positioning of the base 370 relative to the tooth is made, and the resin is cured, for example using an ultraviolet or visible light, to secure the splint post 350 to the lower right lateral incisor 52. The same procedure is repeated for the lower right central incisor 50 and the lower left central incisor 51. Next, the lower right canine 54 is cleaned, etched, rinsed, and dried. Then the strip 320 is then inserted through the passages 360 of each of the secured splint posts 350 (i.e., the splint posts 350 secured to the lower right lateral incisor 52, the lower right central incisor 50, and the lower left central incisor 51). It should be apparent to one skilled in the art that the use of an additional non-mobile tooth (e.g., the lower right canine 54) is for exemplary purposes and is not to be perceived as limiting the current embodiment in any manner.

As illustrated in FIG. 17, strip 320 includes a fixed splint post 350a attached to a first end. Thus, the other end (i.e., the end opposite the fixed splint post 350a) is inserted though the passages 360 of the splint posts 350 that have already been secured to the teeth. Once the strip 350 is inserted into the passages 360 of each of the splint posts 350, the fixed splint post 350a is aligned with the lower right canine 54. The peel strip is removed from the base 370 of splint post 350a to reveal the resin. The base 370, with the resin exposed, is then aligned and pressed against the etched surface of the lower right canine 54. Final positioning of the base 370 relative to the tooth 54 is made, and the resin is cured, for example using an ultraviolet or visible light, to secure the splint post 350a to the lower right canine 54. The end of strip 320 (i.e., the end opposite the splint post 350a) may be trimmed as necessary, for example, to eliminate any material that protrudes from the passage 360 of the splint post 350 secured to the lower left central incisor 51.

It should be apparent to one skilled in the art that methods (other than those illustrated in FIGS. 16 and 17), may be used to apply the splint 300 while remaining within the scope of the present invention. For example, a bonding agent may be applied to the teeth prior to securing the splint 300. Furthermore, it should be apparent to one skilled in the art that the splint 300 may be easily adapted to be used to securing a broken jaw. For example, wires or stays may be interconnect the strip 320 of a splint 300 attached to the teeth in the lower jaw to the strip 320 of a splint 300 attached to the teeth in the upper jaw. As another example, splint posts 350, 350a may be adapted to accept and hold a wire.

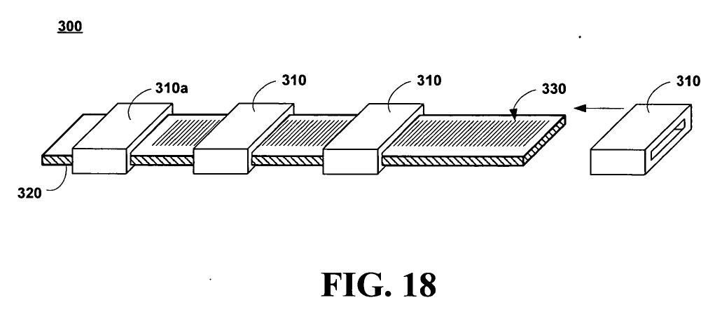

In the current embodiment, the shape of the domed top 380 may improve the comfort level of the patient by eliminating any sharp or pointed edges that may cut or pierce the patient's gums, cheek, lip, etc. It should be apparent to one skilled in the art that other shapes may be used for the splint posts and/or strip while remaining within the scope of the present invention. For example, the passage 360 may be round to accept a round strip 320. As another example, splint posts having a different shaped base and top may be used. FIG. 18 is a perspective view of the front of a dental splint 300 which uses rectangular splint posts 31 (i.e., the base and top are rectangular) according to another embodiment. As illustrated in FIG. 18, dental splint 300 includes a plurality of rectangular splint posts 31, one or more of which may be a fixed splint post 31 a. The dental splint 300 illustrated in FIG. 18 may be secured to a patient's teeth in the same manner as discussed above in conjunction with the splint 300 of FIG. 14A.

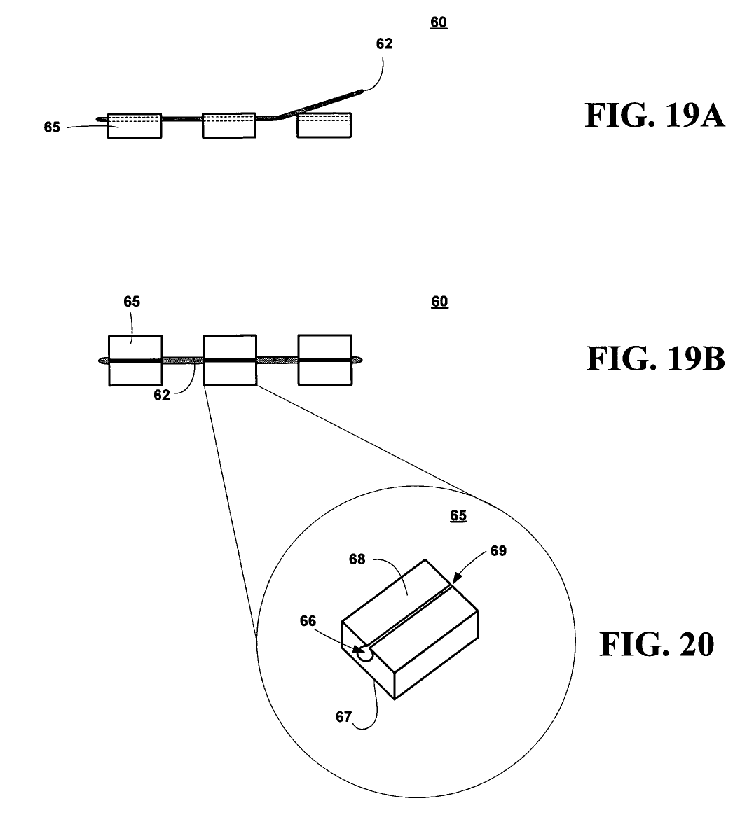

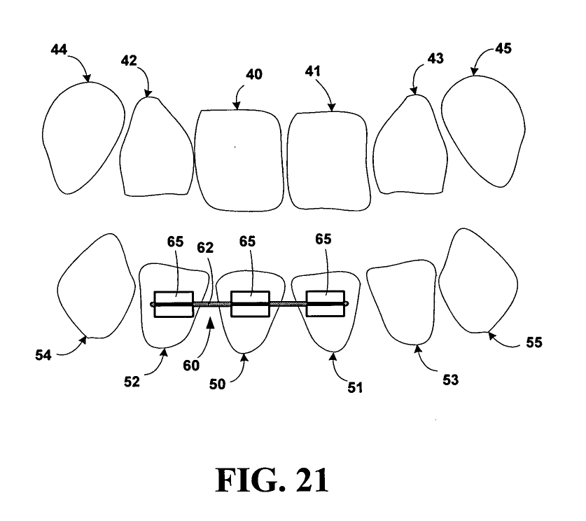

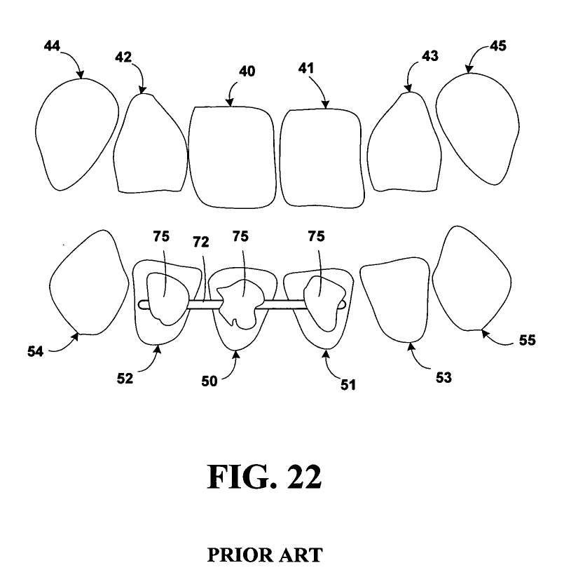

FIGS. 19A and 19B are simplified side and simplified top views of a dental splint 60 according to another embodiment. Dental splint 60 includes a strip 62 and a plurality of splint posts 65, one or more which may be fixed onto the strip 62 (not shown). In the current embodiment, the strip 62 and/or splint posts 65 are made from a resilient plastic material (e.g., polypropylene), however, other materials (e.g., stainless steel) may be used while remaining within the scope of the present invention.

FIG. 20 is an exploded, perspective view of a splint post 65 for the dental splint 60 shown in FIGS. 19A and 19B according to one embodiment. The splint post 65 is rectangular in shape. The bottom or base 67 of the splint post 65 includes a peel strip (not shown) that that can be removed to expose a resin (not shown). The resin, which in the current embodiment is situated on the bottom surface of the base 67, is used to secure the splint post 65 to a patient's tooth.

The upper portion or top 68 of the splint post 65 includes a passage 66 disposed along the longitudinal axis of splint post 65. The shape of the passage 66 may be selected to match the shape of the strip 62. In the current embodiment, for example, a cross-section of the passage 66 is substantially round in shape to match the cross-section of the strip 62. The passage 66 may have a diameter that is slightly larger than the cross-sectional outer diameter of the strip 62 so as to allow the strip 62 to move within the passage 66 with the application of a certain amount of force, but is not so free as to fail to provide support to the mobile tooth. More specifically in the current embodiment, the passage 66 and strip 62 combination provides sufficient support to stabilize the mobile tooth while allowing certain amount of physiological movement so as to prevent ankylosis.

The passage 66 may be accessed via an opening or slit 69 in the top 68 of splint post 66. The slit 66 is also disposed along the longitudinal axis of the splint post 65.

In the current embodiment, the width of the slit 69 (i.e., the width of the opening) is slightly less that the outer diameter of the strip 62 such that the strip 62 may be “snapped” into passage 66. The width of the slit 69 may be selected such that once “snapped,” the strip 66 is retained in passage 66 until removed by a doctor or dentist. In the current embodiment, a semi-rigid and/or flexible material which permits the strip 62 to be “snapped” into the passage 66 without breaking the splint post 65, yet is capable of retaining the strip 62 within the passage 66, may be used for the splint post 65.

FIG. 21 illustrates the use of the splint 60 shown in FIGS. 19A and 19B according to one embodiment. In the embodiment illustrated in FIG. 21, the lower right lateral incisor 52 is cleaned, etched, rinsed, and dried. The peel strip (not shown in FIG. 21) is removed from the base 67 of a splint post 65 to reveal the resin (not shown in FIG. 21). The base 67, with the resin exposed, is then positioned (e.g., aligned and pressed against) relative to the etched surface of the lower right lateral incisor 52. Final positioning of the base 67 relative to the tooth is made and the resin is cured, for example using an ultraviolet or visible light, to secure the splint post 65 to the tooth. The same procedure is repeated for the lower right central incisor 50 and the lower left central incisor 51. Next, the strip 62 is pressed into the slit 69 such that the strip 62 snaps into the passage 66 of the splint post 65 attached to the lower right lateral incisor 52. The strip 62 is then pressed into the slit 69 such that the strip 62 snaps into the passage 66 of the splint post 65 attached to the lower right central incisor 50. Finally, strip 62 is pressed into the slit 69 such that the strip 62 snaps into the passage 66 of the splint post 65 attached to the lower left central incisor 51.

It should be apparent to one skilled in the art that methods (other than that illustrated in FIG. 21), may be used to apply the splint 60 while remaining within the scope of the present invention. For example, a bonding agent may be applied to the tooth surface prior to securing the splint 60 to a patient's teeth. Furthermore, it should be apparent to one skilled in the art that the splint 60 may be easily adapted to be used to securing a broken jaw. For example, wires or stays may be interconnect the strip 62 of a splint 60 attached to the teeth in the lower jaw to the strip 62 of a splint 60 attached to the teeth in the upper jaw. As another example, splint posts 65 may be adapted to accept and hold a wire.

It should be recognized that the above-described embodiments of the invention are intended to be illustrative only. Numerous alternative embodiments may be devised by those skilled in the art without departing from the scope of the following claims. For example, the application of the dental splints to the specific teeth discussed above was for exemplary purposes only and it should be apparent to one skilled in the art that the splint may be applied to other teeth. Furthermore, although the discussion of the specific embodiments was limited to securing the splints to the buccal surface of the teeth, it should be apparent to one skilled in the art that the splints may be applied to another the surface of the tooth (e.g., the lingual, occlusal, etc.) while remaining within the scope of the present invention.

What is claimed is:

1. A dental splint, comprising:
a plurality of splint posts, at least one of said splint posts having a resin thereon; and
a strip interconnecting said plurality of splint posts.

2. The dental splint of claim 1 wherein said splint post includes a removable peel strip for covering said resin.

3. The dental splint of claim 1 wherein at least one of said plurality of splint posts is fixed to said strip.

4. The dental splint of claim 1 wherein at least one of said plurality of splint posts is movable relative to said strip.

5. The dental splint of claim 1 wherein at least one of said plurality of splint posts includes a groove, said groove operable to accept a wire.

6. The dental splint of claim 1 wherein at lease one of said strip or said splint post strip is made from a plastic material or stainless steel.

7. The dental splint of claim 1 wherein said strip includes one or more slots for accepting at least one of said plurality of splint posts, said at least one of said plurality of splint posts being movable within said one or more slots.

8. The dental splint of claim 7 wherein said splint post includes:
a base;
a top; and
a member for connecting said top to said base.

9. The dental splint of claim 8 wherein said member further comprises:
a first portion; and
a second portion, wherein said first and second portions are operable to lockably engage each another.

10. The dental splint of claim 8 wherein said splint post includes a key operable to engage a channel in said strip.

11. The dental splint of claim 1 wherein said splint post includes:
a base; and
a top having a passage therethrough, said passage operable to accept said strip therein.

12. The dental splint of claim 11 wherein said passage includes one or more protrusions operable to engage one or more ridges on said strip.

13. The dental splint of claim 11 wherein said strip is movable relative to at least one of said plurality of splint posts.

14. The dental splint of claim 11 wherein said top includes a slit, said passage being operable to accept said strip via said slit.

15. The dental splint of claim 14 wherein said strip is movable relative to said splint post when said strip is accepted within said passage.

16. The dental splint of claim 15 wherein the cross-sectional shape of said passage is substantially the same as the cross-section shape of said strip.

17. A method of applying a dental splint, comprising:
securing a first splint post to a mobile tooth;
securing a second splint post to a non-mobile tooth, wherein at least one of said first and second splint posts includes a resin thereon; and
interconnecting said one or more splint posts with a strip.

18. The method of claim 17 wherein said securing a first splint post comprises:
exposing said resin of said first splint post;
positioning said first splint post relative to a surface of said mobile tooth; and
curing said resin.

19. The method of claim 18 wherein said exposing a resin comprises removing a peel strip from a base of said first splint post or from a base of said second splint post.

20. The method of claim 17 wherein said securing a second splint post comprises:
exposing said resin of said second splint post;
positioning said second splint post relative to a surface of said non-mobile tooth; and
curing said resin.

21. The method of claim 20 wherein said exposing a resin comprises removing a peel strip from a base of said first splint post or from a base of said second splint post.

22. The method of claim 17 wherein said securing a second splint post to a non-mobile tooth includes securing said second splint post to a non-mobile tooth that is adjacent to said mobile tooth.

23. The method of claim 17 further comprising:
preparing at least one of said mobile tooth or said non-mobile tooth, wherein said preparing comprises:
cleaning a surface of said at least one tooth;
etching said surface of said at least one tooth;
rinsing said surface of said at least one tooth; and
drying said surface of said at least one tooth.

24. The method of claim 23 wherein said preparing at least one of said mobile tooth or said non-mobile tooth further comprises:
applying a bonding material to said surface of said at least one tooth; and
curing said bonding material on said surface of said at least one tooth.

25. The method of claim 17 wherein said interconnecting said one or more splint posts with a strip further comprises inserting said strip into a passage within at least one of said first splint post or said second splint post.

26. The method of claim 25 wherein said strip is inserted into said passage via a slit.

27. A method of applying a dental splint, comprising:
securing a first splint post to a mobile tooth; and
securing a second splint post to a non-mobile tooth, wherein said first and second splint posts are interconnected by a strip and wherein at least one of said first and second splint posts includes a resin thereon.

28. The method of claim 27 wherein said securing a first splint post comprises:
exposing said resin of said first splint post;
positioning said first splint post relative to a surface of said mobile tooth; and
curing said resin.

29. The method of claim 28 wherein said exposing a resin comprises removing a peel strip from a base of said first splint post or from a base of said second splint post.

30. The method of claim 27 wherein said securing a second splint post comprises:
exposing said resin of said second splint post;
positioning said second splint post relative to a surface of said non-mobile tooth; and
curing said resin.

31. The method of claim 30 wherein said exposing a resin comprises removing a peel strip from a base of said first splint post or from a base of said second splint post.

32. The method of claim 27 wherein said securing a second splint post to a non-mobile tooth includes securing said second splint post to a non-mobile tooth that is adjacent to said mobile tooth.

33. The method of claim 27 further comprising:
preparing at least one of said mobile tooth or said non-mobile tooth, wherein said preparing comprises:
cleaning a surface of said at least one tooth;
etching said surface of said at least one tooth;
rinsing said surface of said at least one tooth; and
drying said surface of said at least one tooth.

34. The method of claim 33 wherein said preparing at least one of said mobile tooth or said non-mobile tooth further comprises:
applying a bonding material to said surface of said at least one tooth; and
curing said bonding material on said surface of said at least one tooth.

35. The method of claim 27 further comprising dry fitting said dental splint.
